(19) United States
(12) Patent Application Publication
(10) Pub. No.: US 2025/0241238 A1
(43) Pub. Date: Jul. 31, 2025

(54) Mower

(71) Applicant: CLAAS Saulgau GmbH, 88348 Bad Saulgau (DE)

(72) Inventors: Christian Speer, Aach (DE); Josef Fischer, Biberach (DE)

(21) Appl. No.: 19/039,178

(22) Filed: Jan. 28, 2025

(30) Foreign Application Priority Data
Jan. 29, 2024 (DE) 102024102486.0

(51) Int. Cl. A01D 34/73; A01D 34/82; A01D 101/00

(52) U.S. Cl. CPC A01D 34/73; A01D 34/82; A01D 2101/00

(57) ABSTRACT

Mower (1) of an agricultural harvesting machine, comprising a plurality of mowing members (2a, 2b) which are positioned next to one another in a row to form a cutter bar (3), wherein each mowing member (2a, 2b) has a cutter disk (4a, 4b), wherein the cutter disks (4a, 4b) of directly adjacent mowing members (2a, 2b) are arranged alternately in different planes, namely, in the working position of the mower (1), first cutter disks (4a) of first mowing members (2a) are arranged in a first, lower plane and second cutter disks (4b) of second mowing members (2b) are arranged in a second, upper plane, and wherein the cutter disks (4a, 4b) of directly adjacent mowing members (2a, 2b) overlap in a projection, and comprising a housing (7) having a transmission bar (8), wherein a transmission, which serves to drive the cutter disks (4a, 4b), is at least partially arranged in the transmission bar (8), and wherein the transmission bar (8) is arranged below the cutter disks (4a, 4b) in the working position of the mower. At least one first clearing member (11a) with a first length is arranged between each first cutter disk (4a) and the transmission bar (8a), and at least one second clearing member (11b) with a second length differing from the first length is arranged between each second cutter disk (4b) and the transmission bar (8).

The invention relates to a mower according to the preamble of Claim 1.

DE 1 945 760 U discloses a cutting bar for a mowing machine. The cutting bar has a plurality of mowing members positioned next to one another in a row, wherein the mowing members have cutter disks. The cutter disks of directly adjacent mowing members overlap in one projection, wherein the cutter disks of directly adjacent mowing members are arranged in different planes. Thus, in a working position of the mower, first cutter disks of first mowing members are arranged in a first, lower plane and second cutter disks of second mowing members are arranged in a second, upper plane. Furthermore, a housing with a transmission bar is shown, wherein chain wheels extend in the transmission bar of the housing and form a transmission for driving the cutter disks. In the working position of the mower, the transmission bar is arranged below the cutter disks.

Mowed material can accumulate between the cutter disks and the transmission bar in the mower insert and cause blockages.

There is a need for a mower that reduces the risk of cut crop collecting between the mower disks and the transmission bar, which can lead to blockages.

EP 3 942 919 A1 shows an attachment for an agricultural harvester for harvesting maize or grain. The attachment has cutting devices and revolving driver devices during operation. Each driver device has driver elements arranged above the cutting devices for conveying cut crops.

EP 3 143 865 B1 discloses a further mower according to the prior art, the mowing members of which, however, do not have cutter disks, but blade carriers with blades mounted on the blade carrier.

On this basis, the present invention addresses the problem of creating a new type of mower. This problem is solved by a mower according to Claim 1.

According to the invention, at least one first clearing member with a first length is arranged between each first cutter disk and the transmission bar and at least one second clearing member with a second length differing from the first length is arranged between each second cutter disk and the transmission bar. With the mower according to the invention, the risk of unintentionally cut mowed material or crop accumulating between the transmission bar and the cutter disks can be reduced. This can also reduce the risk of blockages on the mower. A clean, reliable crop flow is made possible.

Preferably, the first length of the first clearing members is greater than the second length of the second clearing members. This can advantageously reduce the risk of mowed material or crop accumulating between the cutter disks and the transmission bar.

Preferably, cutting tips of each first cutter disk lie on a respective first circular path and cutting tips of each second cutter disk lie on a respective second circular path, wherein the first circular path and the second circular path of directly adjacent mowing members overlap in the projection, wherein one end of the respective first clearing member extends to the respective first circular path, and wherein one end of the respective second clearing member ends at a radial distance from the respective second circular path. The risk of unintentionally cut mowed material or crop accumulating between the transmission bar and the cutter disks can be advantageously reduced.

According to a first alternative, the second length of the respective second clearing member is dimensioned such that the end of the respective second clearing member ends at a distance from the respective first circular path of a respective directly adjacent first cutter disk.

According to a second alternative, the second length of the respective second clearing member is dimensioned such that the end of the respective second clearing member extends beyond the respective first circular path of a respective directly adjacent first cutter disk.

In the first alternative, the first clearing members and the second clearing members can be, while in the second alternative they must be, offset from one another by preferably 30° to 90° to provide a phase offset. Both alternatives can reduce the risk of cut crop or mowed material accumulating between the transmission bar and the cutter disks.

Preferably the first clearing members have a first thickness and the second clearing members have a second thickness, wherein the second thickness is greater than the first thickness. This also serves to further reduce the risk of crop or mowed material accumulating between the transmission bar and the cutter disks.

Preferably, each mowing member has a cutter flange in addition to the respective cutter disk, on which cutter flange the respective cutter disk is supported, wherein the respective clearing member is attached at least to the respective cutter flange. The respective clearing member can also be attached to the respective cutter disk. Preferably, the first clearing members with the greater length are also attached to the cutter disks. This reduces the risk of damage to the respective clearing members during mowing operation.

Preferably, the respective first clearing member and/or the respective second clearing member has a stepped or curved or bent contour adapted to the transmission bar on its side facing the transmission bar. This makes it possible to optimally clear the area between the transmission bar and the cutter disks via the clearing members of cut mowed material or crop and thus reduce the risk of crop accumulating between the cutter bar and the cutter disks, leading to blockages.

Preferred developments of the invention can be found in the dependent claims and the following description. Exemplary embodiments of the invention are explained in greater detail, without being limited thereto, with reference to the drawing, in which:

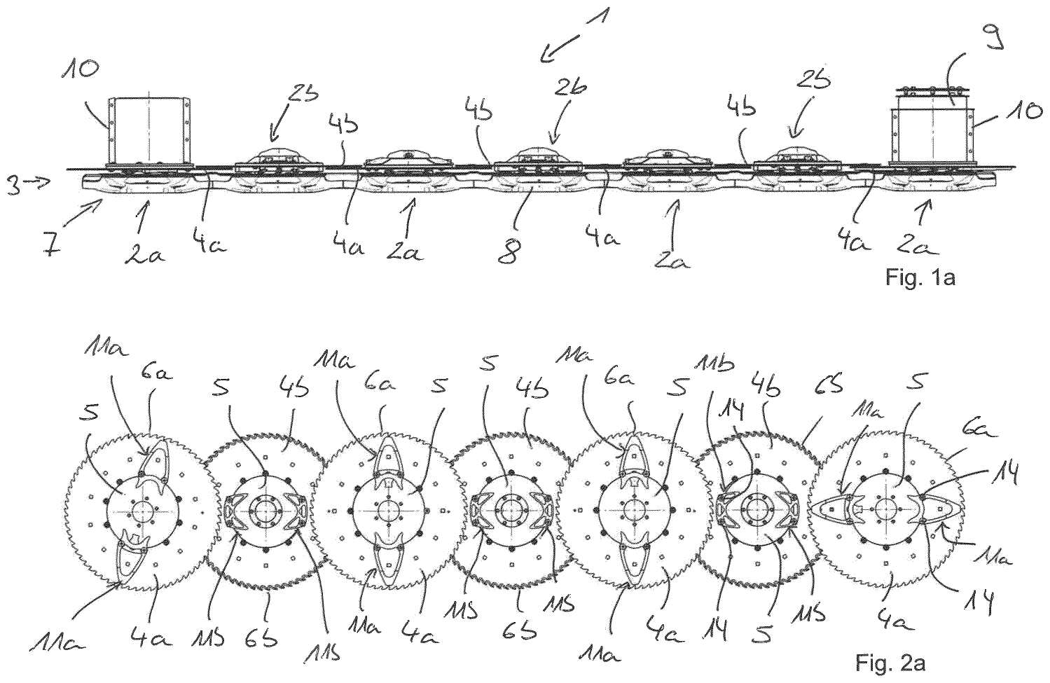

FIG. 1a shows a front view of a mower according to the invention;

FIG. 1b shows a detail of FIG. 1a;

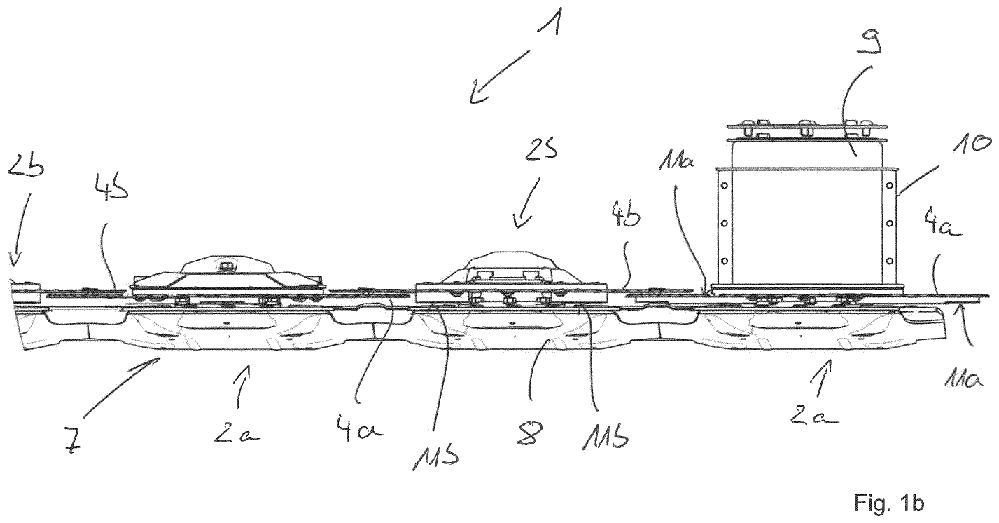

FIG. 2a shows a view from below of the mower of FIG. 1 without transmission bar, namely of first and second mowing members and first and second clearing members,

FIG. 2b shows a detail of FIG. 2a;

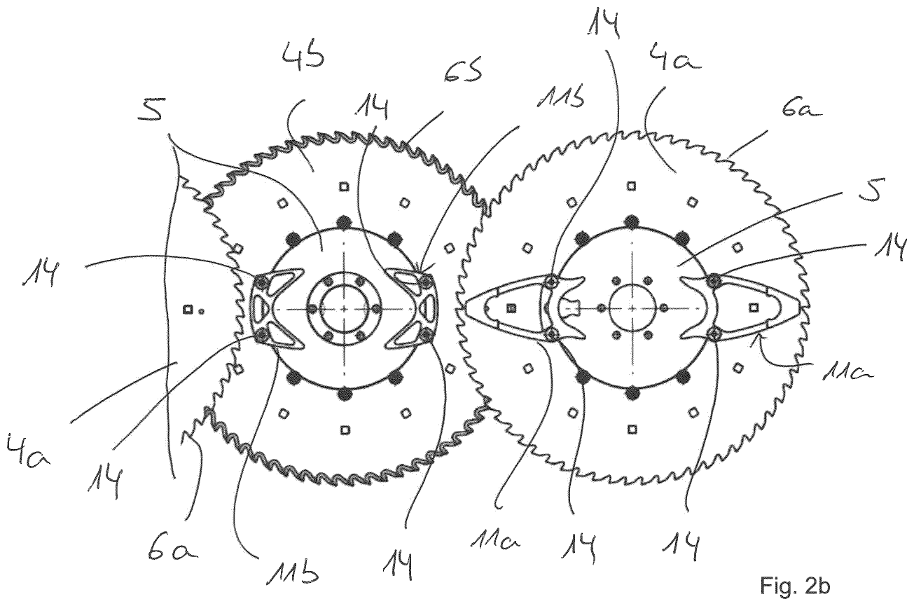

FIG. 3a shows a perspective view from below of an alternative first mowing member and alternative first clearing members,

FIG. 3b shows a detail of FIG. 3a,

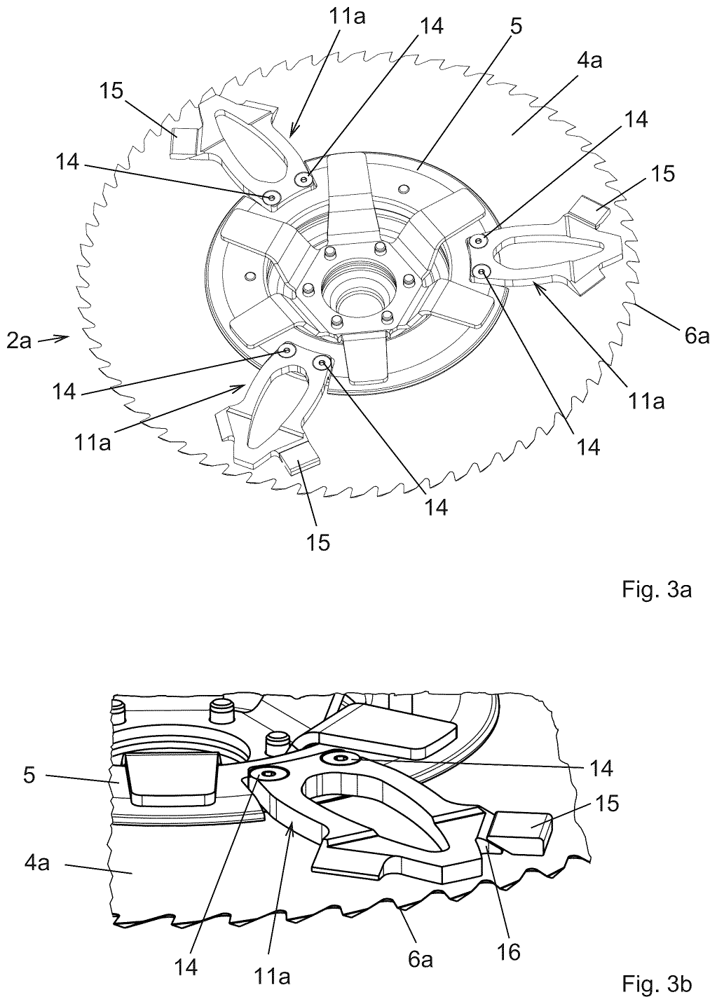

FIG. 4a shows a perspective view from below of a further alternative first mowing member and alternative first clearing members,

FIG. 4b shows a detail of FIG. 4a,

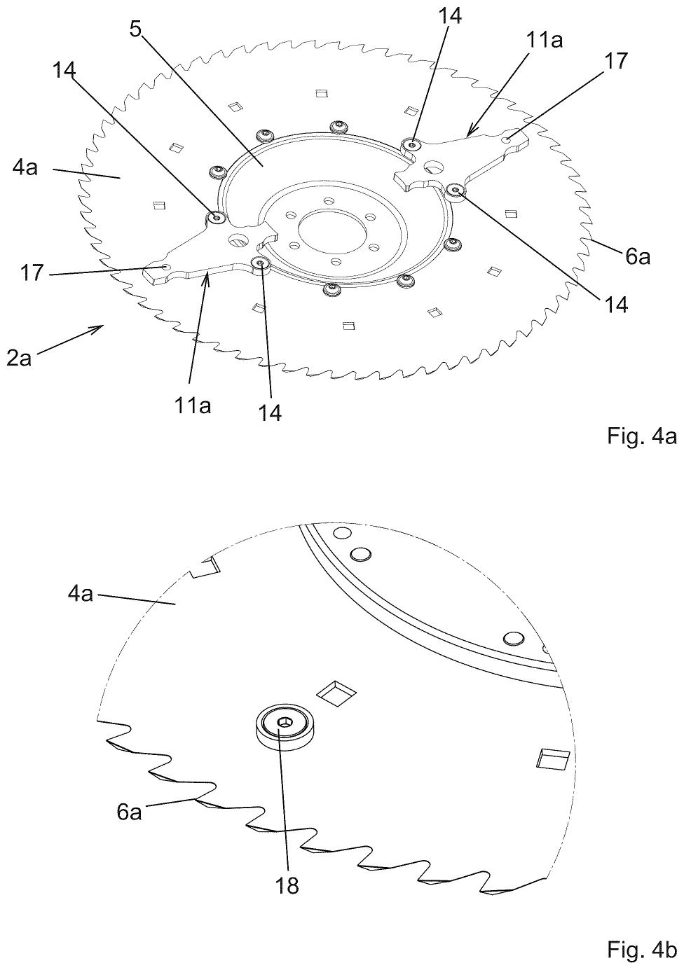

FIG. 5 shows a detail from below of an alternative mower, namely of first and second mowing members and first and second clearing members,

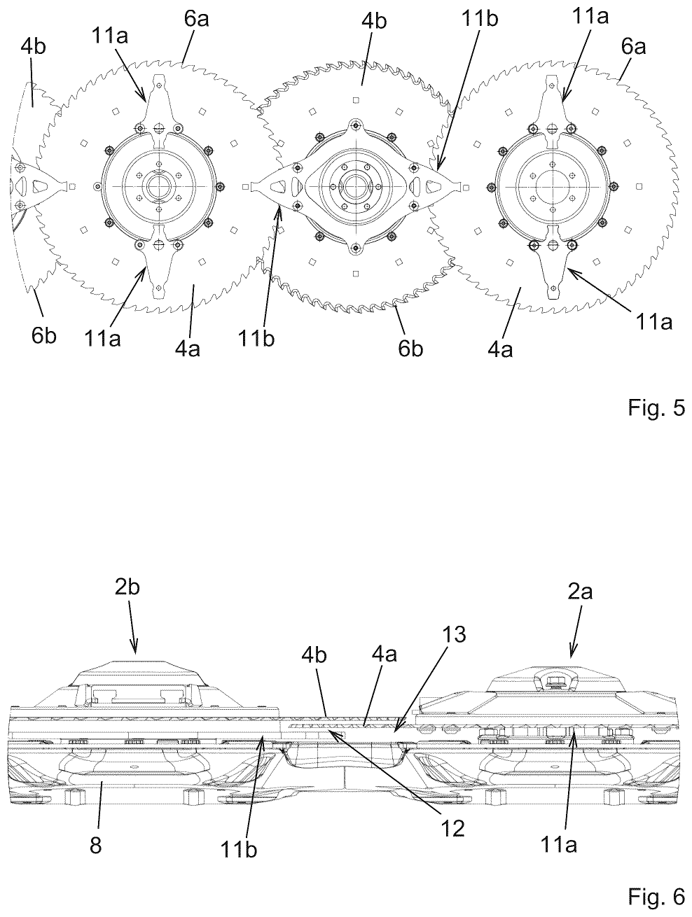

FIG. 6 shows a detail of FIG. 5 in side view.

FIG. 1a shows a front view of a mower 1 of an agricultural harvester. The mower 1 has a plurality of mowing members 2a, 2b, which are positioned next to one another in a row to form a cutter bar 3.

Each mowing member 2a, 2b has a cutter disk 4a, 4b. FIG. 2a shows a view from below of the cutter disks 4a, 4b of the mowing members 2a, 2b.

The cutter disks 4a, 4b of directly adjacent mowing members 2a, 2b are arranged alternately in different planes. Thus, in the working position of the mower 1, first cutter disks 4a of the first mowing units 2a are arranged in a first, lower plane and second cutter disks 4b of the second mowing units 2b are arranged in a second, upper plane.

The cutter disks 4a, 4b of directly adjacent mowing members 2a, 2b overlap, as seen in a projection from above or from below. This overlapping of the cutter disks 4a, 4b of directly adjacent mowing members 2a, 2b can be seen in particular in FIGS. 2a, 2b.

Each cutter disk 4a, 4b of each mowing unit 2a, 2b is supported on a so-called cutter flange 5 of the respective mowing unit 2a, 2b.

As can be seen from FIGS. 2a, 2b, the cutter disks 2a, 2b have a circular outer contour, with cutting tips 6a, 6b of each cutter disk 4a, 4b lying on a respective circular path. Thus, the cutting tips 6a of each first cutter disk 4a lie on a first circular path in the first, lower plane and the cutting tips 6b of the second cutter disks 4b lie on a second circular path in the second, upper plane.

The first circular path and the second circular path of directly adjacent mowing members 2a, 2b and thus directly adjacent cutter disks 4a, 4b overlap as seen in the projection, namely in a viewing direction from above or from below. However, due to the fact that the cutter disks 4a, 4b of directly adjacent mowing members 2a, 2b are arranged in different planes at a distance from one another, the cutter disks 4a, 4b can rotate freely.

The mower 1 also has a housing 7, which has a so-called transmission bar 8. In the working position of the mower 1, the transmission bar 8 is arranged below the mowing members 2a, 2b and thus below the cutter disks 4a, 4b thereof. A transmission is arranged at least partially in the transmission bar 8 and serves to drive the cutter disks 4a, 4b, starting from a drive 9 of the mower 1.

As shown in FIG. 1a, the drive 9 is arranged together with a deflector 10 on a first side of the mower 1 or the cutter bar 3. Only the deflector 10 is present on the opposite side of the mower 1 or cutter bar 3.

As explained above, in the working position of the mower 1, the transmission bar 8 is therefore arranged below the mowing members 2a, 2b and therefore below the cutter disks 4a, 4b. In the working position of the mower, the first cutter disks 4a of the first mowing members 2a are located in a first, lower plane and the second cutter disks 4b of the second mowing members 2b are located in a second, upper plane above the transmission bar 8. The transmission bar 8 is therefore arranged below these two planes of the first and second cutter disks 4a, 4b.

At least one respective first clearing member 11a is arranged between each first cutter disk 4a of a respective first mowing member 2a and the transmission bar 8. In the exemplary embodiment of FIGS. 1a, 1b, 2a, 2b, two first clearing members 11a are arranged between each first cutter disk 4a and the transmission bar 8. The respective first clearing member 11a has a first length. The first length extends in the radial direction of the respective first cutter disk 4a.

A second clearing member 11b is arranged between each second cutter disk 2b of the respective second mowing member 2b and the transmission bar 8. In the exemplary embodiment of FIGS. 1a, 1b, 2a, 2b, two second clearing members 11b are arranged in each case between the second cutter disk 4b of a respective second mowing member 2b and the cutter bar 8. The respective second clearing member 11b has a second length that differs from the first length of the first clearing members 11a. The second length extends in the radial direction of the respective second cutter disk 4b.

According to FIGS. 2a, 2b, the first lengths of the first clearing members 11a are greater than the second lengths of the second clearing members 11b. These lengths define the extent of the clearing members 11a, 11b in the radial direction of the mowing members 2a, 2b or in the radial direction of the cutter disks 4a, 4b.

If, as shown in the exemplary embodiment, two clearing members 11a, 11b are arranged between the respective cutter disk 4a, 4b and the cutter bar 8, these clearing members 11a and 11b are diametrically opposite one another. This prevents an imbalance. If there is only one clearing member between the respective cutter disk 4a, 4b and the respective cutter bar 8, a counterweight for the respective clearing member 11a, 11b is preferably installed on the respective cutter disk 4a, 4b to avoid an unbalance.

In the exemplary embodiment of FIGS. 2a, 2b, one end of the respective first clearing member 11a extends up to the respective first circular path on which the cutting tips 6a of the respective first cutter disk 4a are positioned. The radially outer ends of the respective second clearing member 11b end at a radial distance from the respective second circular path on which the cutting tips 6b of the respective second cutter disk 4b are positioned.

In the exemplary embodiment of FIGS. 2a, 2b, the length of the respective second clearing member 11b is dimensioned such that the end of the respective second clearing member 11b ends at a distance from the respective first circular path of a respective directly adjacent first cutter disk 4a, on which the cutting tips 6a of the respective directly adjacent first cutter disk 4a are arranged.

By contrast, FIGS. 5 and 6 show an alternative embodiment of a mower 1, in which the second length of the respective second clearing member 11b is dimensioned such that the end of the respective second clearing member 11b extends beyond the respective first circular path of a respective directly adjacent first cutter disk 4a of a directly adjacent mowing member 2a, in which the radial extent of a respective second clearing member 11b thus intersects the first circular path of a respective directly adjacent first cutter disk 4a. In this case, it is then provided that the first clearing members 11a and the second clearing members 11b of the directly adjacent cutter disks 4a, 4b are offset relative to one another as viewed in the circumferential direction, in order to provide a phase offset between the first and second clearing members 11a, 11b in such a way that they cannot touch one another during rotation in operation.

In particular, the first clearing members 11a and the second clearing members 11b of the directly adjacent cutter disks 4a, 4b are offset from one another by an angle of 30° to 90° when viewed in the circumferential direction.

According to FIG. 6, the respective second clearing member 11a has a recess 12 into which the directly adjacent cutter disk 4a of a directly adjacent mowing member 2a extends. Accordingly, the respective second clearing member 11a has a first, upper portion, which has a radial distance to the directly adjacent cutter disk 4a of the directly adjacent first mowing member 2a, as well as a second, underlying portion, which overlaps in projection with the directly adjacent cutter disk 4a of the directly adjacent mowing member 2a and projects into a free space 13 between the cutter disk 4a of the directly adjacent mowing member 2a and in the transmission bar 8.

The first clearing members 11a have a first thickness and the second clearing members 11b have a second thickness, wherein the second thickness is greater than the first thickness. The thickness of the clearing members depends in particular on the distance of the respective cutter disks 4a, 4b of the respective mowing member 2a, 2b from the transmission bar 8. If more than one clearing member 11a, 11b works together with a cutter disk 4a, 4b, the respective clearing members 11a, 11b can have different thicknesses.

The respective clearing members 11a, 11b are fastened in the region of the respective mowing member 2a, 2b at least to the respective cutter flange 5, in particular by screwing. Thus, it can be seen in particular from FIG. 2b that each of the clearing members 11a, 11b is fastened via screws 14 to the respective cutter flange 5 of the respective mowing member 2a, 2b, on which the respective cutter disk 4a, 4b of the respective mowing member 2a, 2b is supported.

FIGS. 3a, 3b show an alternative embodiment of a first mowing member 2a with a first cutter disk 4a and three first clearing members 11a. The three clearing members 11a are equally distributed along the circumference of the cutter disk 4a, wherein the clearing members 11a are in turn attached to the respective cutter flange 5 via screws 14.

In FIGS. 3a and 3b, the first clearing members 11a shown there are furthermore fastened to the cutter disk 4a, specifically in that a protrusion 16 of a respective first clearing member 11a engages underneath a protrusion 15 on the respective first cutter disk 4a of the respective first mowing member 2a, so that here the first clearing member 11a is fastened to the cutter disk 4a in a form-fitting manner. According to FIG. 3a, each of the first clearing members 11a shown there is fastened to the cutter flange 5 via the screws 4a, and there is also a form fit between a protrusion 16 of each first clearing member 11a and a corresponding protrusion 15 of the cutter disk 4a.

FIGS. 4a and 4b show further alternatives of the first mowing member 2a with a first cutter disk 4a and, in this case, two first clearing members 11a, which in turn are diametrically opposite one another and are fastened to the cutter flange 5 of the screws 14 via screws 14. In FIGS. 4a and 4b, the first clearing members 11a are fastened via further screws 17 to the first cutter disk 4a, which provides a corresponding screw-on point 18 for this purpose.

The clearing members 11a, 11b have a contour adapted to the transmission bar 8 on their side facing the transmission bar 8. This contour can be stepped, arched or curved in order to optimally cover the area to be cleared between the respective cutter disk 4a, 4b and the transmission bar 8. This contour can be stepped, arched or curved, depending on the corresponding contouring of the transmission bar 8 on its side facing the cutter disks 4a, 4b.

### LIST OF REFERENCE SIGNS

1 mower
2a mowing member
2b mowing member
3 cutter bar
4a cutter disk
4b cutter disk
5 cutter flange
6a cutting tip
6b cutting tips
7 housing
8 transmission bar
9 drive
10 deflector
11a clearing member
11b clearing member
12 recess
13 free space
14 screw
15 protrusion
16 protrusion
17 screw
18 screw-on point

1. A mower (1) of an agricultural harvester,
comprising a plurality of mowing members (2a, 2b), which are positioned next to one another in a row to form a cutter bar (3)
wherein each mowing member (2a, 2b) has a cutter disk (4a, 4b),
wherein the cutter disks (4a, 4b) of directly adjacent mowing members (2a, 2b) are arranged alternately in different planes, namely, in the working position of the mower (1), first cutter disks (4a) of first mowing members (2a) are arranged in a first, lower plane and second cutter disks (4b) of second mowing members (2b) are arranged in a second, upper plane,
wherein the cutter disks (4a, 4b) of directly adjacent mowing members (2a, 2b) overlap in one projection,
comprising a housing (7) having a transmission bar (8),
wherein a transmission, which serves to drive the cutter disks (4a, 4b), is at least partially arranged in the transmission bar (8),
wherein the transmission bar (8) is arranged below the cutter disks (4a, 4b) in the working position of the mower,
characterized in that
at least one first clearing member (11a) with a first length is arranged between each first cutter disk (4a) and the transmission bar (8a) and at least one second clearing member (11b) with a second length differing from the first length is arranged between each second cutter disk (4b) and the transmission bar (8).

2. The mower according to claim 1, characterized in that
the first length of the first clearing members (11a) is greater than the second length of the second clearing members (11b).

3. The mower according to claim 1, characterized in that
cutting tips (6a) of each first cutter disk (4a) lie on a respective first circular path,
cutting tips (4b) of each second cutter disk (4b) lie on a respective second circular path,
the first circular path and the second circular path of directly adjacent mowing members (2a, 2b) overlap in the projection,
one end of the respective first clearing member (11a) extends to the respective first circular path,
one end of the respective second clearing member (11b) ends at a radial distance from the respective second circular path.

4. The mower according to claim 3, characterized in that
the second length of the respective second clearing member (11b) is dimensioned such that the end of the respective second clearing member (11b) ends at a distance from the respective first circular path of a respective directly adjacent first cutter disk (4a).

5. The mower according to claim 3, characterized in that
the second length of the respective second clearing member (11b) is dimensioned such that the end of the respective second clearing member (11b) extends beyond the respective first circular path of a respective directly adjacent first cutter disk (4a).

6. The mower according to claim 1, characterized in that
the first clearing members (11a) and the second clearing members (11b) are offset from one another by preferably 30° to 90° to provide a phase offset between the first clearing members (11a) and the second clearing members (11b).

7. The mower according to claim 1, characterized in that
the first clearing members (11a) have a first thickness and the second clearing members (11b) have a second thickness, wherein the second thickness is greater than the first thickness.

8. The mower according to claim 1, characterized in that
each mowing member (2a, 2b) has a cutter flange (5) in addition to the respective cutter disk (4a, 4b), on which the respective cutter disk (4a, 4b) is supported,
the respective clearing member (11a, 11b) is attached at least to the respective cutter flange (5).

9. The mower according to claim 8, characterized in that
the respective clearing member (11a, 11b) is additionally attached to the respective cutter disk (4a, 4b).

10. The mower according to claim 1, characterized in that
the respective first clearing member (11a) and/or the respective second clearing member (11b) has a stepped or curved or bent contour adapted to the transmission bar (8) on its side facing the transmission bar (8).
